(19) United States
(12) Patent Application Publication
(10) Pub. No.: US 2024/0166917 A1
(43) Pub. Date: May 23, 2024

(54) SEALANT REMOVER

(71) Applicant: Illinois Tool Works Inc., Glenview, IL (US)

(72) Inventors: Donald Cooper, Glenview, IL (US); Matthew Rhodes, Glenview, IL (US); Jonathan A. Long, Glenview, IL (US)

(73) Assignee: Illinois Tool Works Inc., Glenview, IL (US)

(21) Appl. No.: 18/387,155

(22) Filed: Nov. 6, 2023

Related U.S. Application Data
(60) Provisional application No. 63/423,837, filed on Nov. 9, 2022.

(51) Int. Cl. C09J 5/00

(52) U.S. Cl. CPC C09J 5/00; C09J 2301/502

(57) ABSTRACT

A sealant removal composition provided that includes a pyrrolidone solvent, a non-ionic surfactant, and at least one co-solvent. The composition is well suited to removal sulfur-based polymer and silicone-based polymer sealant. A process of removing a sealant from a substrate is provided that includes applying the composition to the sealant. After allowing dwell time for the sealant to swell on the substrate, the sealant is removed.

### RELATED APPLICATIONS

This application is a non-provisional application that claims priority benefit of U.S. Provisional Application Ser. No. 63/423,837 filed Nov. 9, 2022; the contents of which are hereby incorporated by reference.

### FIELD OF THE INVENTION

The present invention relates in general to the technical field of removing cured sealants, and, in particular, to removing cured sealants with compositions having superior handling properties.

### BACKGROUND OF THE INVENTION

Silicones and sulfur-containing polymers such as polysulfides and polythioethers are widely used in the aerospace, construction, and insulating-glass industries in a variety of applications that require solvent resistance, water-immersion resistance, shrink resistance, and substrate adhesion. Common substrates include glass, metal, and concrete. Exemplary uses include liquid storage coatings and gaskets.

Polysulfides are typically created through the cure of bis(chloroethyl)formal, sodium polysulfide, and a small amount of trivalent crosslinking agent. The cure product is digested to form a thiol-terminated prepolymer that is oxidation cured to yield a polysulfide sealant.

Other types of sulfur-containing polymers include polythiophenes, polythioethers, and polydisulfides.

For all the properties that make silicone and sulfur-containing polymers excellent sealants, those same properties often make these materials difficult to remove. As mechanical removal is often difficult from complex substrates and can lead to substrate surface marring, yet solvents, even including difficult to handle solvents such as halogenated organic solvents and terpenes, are not particularly effective at swelling cured silicone and sulfur-containing polymer sealants. Aggressive solvents have met with more success in removing uncured or partially cured silicones and sulfur-containing polymers.

Conventional solvents for removing uncured or partially cured silicones and sulfur-containing polymers have included: citrus-based solvent systems, such as d-limonene; volatile ketones, such as those including at least one of methyl ethyl ketone, methyl propyl ketone, or acetone; petroleum solvent-based such as those including at least one of mineral spirits, naphthenic, and paraffinic distillates. A fundamental problem of these conventional solvents is that while a low molecular weight solvent molecule is well-suited for penetration into the sealant composition, low molecular weight is associated with high vapor pressure and thus faster evaporation rates. Conventional solvents also tend to have low flashpoints that require flammability handling precautions.

These limitations of conventional solvents for removing uncured or partially cured silicones and sulfur-containing polymers manifest use complications in that reduced contact dwell times due to solvent evaporation requires frequent re-applying to obtain a sufficient dwell time to soften the sealant. Also, to the extent that solvents volatile organic compounds (VOCs) or hazardous air pollutants (HAPs), handling is complicated to be complaint with safe handling requirements. Other solvent specific issues include the fact that citrus terpenes can be irritating to the respiratory tract in high concentrations and irritating to the skin with prolonged use.

While pyrrolidones have been contemplated to address the limitation of other solvents, these have only been used in solvent mixtures in which the pyrrolidones represent the majority by weight of the solvent mixture, with more than 50 percent by weight of the sealant removing solvent being a pyrrolidone or a combination of pyrrolidones and lacking non-ionic surfactants. Such solvent mixtures are detailed in U.S. Pat. No. 5,561,215. Inclusion of VOC solvents have limited the acceptance of these sealant removers.

Thus, there exists a need for a solvent system capable of overcoming the limitations of the prior art as to silicones and sulfur-containing polymers.

### SUMMARY OF THE INVENTION

A sealant removal composition in provided that includes a pyrrolidone solvent, a non-ionic surfactant, and at least one co-solvent. The composition is well suited to removal sulfur-based polymer and silicone-based polymer sealant.

A process of removing a sealant from a substrate is provided that includes applying the composition to the sealant. After allowing dwell time for the sealant to swell on the substrate, the sealant is removed.

### DETAILED DESCRIPTION OF THE INVENTION

The present invention has utility as a solvent composition for sealant removal that includes a synergistic combination of solvents and a surfactant to achieve efficient removal of sulfur-based polymer and silicone-based polymer sealant, regardless of the extent of sealant cure. The solvent composition achieves this result in some inventive embodiments without resort to flammable or VOC solvents as defined in GHS Revision 3 (adopted by OSHA in 2012). The present invention affords sealant removal properties with better human health and environmental properties compared to conventional sealant removers.

Without intending to be bound by a particular theory, the present invention is believed to include a nonionic surfactant that promotes sealant penetration and solvent swell of the sealant, even when fully cured. In some embodiments of the present invention includes a propellant, a thickener, or a combination thereof for specialized uses.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

Typical and preferred sealant removing compositions according to the present inventions are provided in the Table.

TABLE
Inventive Sealant Removal Composition (amounts in
total weight percent unless otherwise noted).

| Ingredient | Typical | Preferred |
|---|---|---|
| Pyrrolidone solvent | 5-45 | 15-35 |
| Non-ionic surfactant(s) | 10-40 | 17-35 |
| Co-solvents - total | Remainder | Remainder |
| one or more of: | | |
| Polyalkoxys (glyme/polyethers) | 10-30 | 15-25 |
| Amide | 10-40 | 20-30 |
| Acetal/ketal | 10-30 | 15-25 |
| Wetting agent | 0-15 | 5-10 |
| Additives | 0-5 each | 0.5-3 each |
| | independently | independently |

An inventive sealant removal composition includes a pyrrolidone solvent, synonymously referred to a lactam solvent. A pyrrolidone operative herein has the cyclic structure (I):

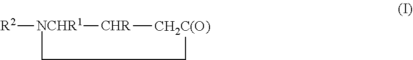

where R¹ is hydrogen, or C₁-C₃ linear alkyl; R² is hydrogen, C₁-C₁₂ linear alkyl, C₁-C₁₂ branched alkyl, C₅-C₁₂ cyclic alkyl, or C₁-C₁₂ linear alkoxy; and R is hydrogen, or —C₆R³₅; where R³ in each occurrence is independently hydrogen, —C₆H₅, and substituted C₆ aryl with one or more hydrogen substituted by C₁-C₁₂ linear alkyl, C₁-C₁₂ branched alkyl, or C₅-C₁₂ cyclic alkyl. Specific pyrrolidones operative herein illustratively include pyrrolidone, N-methyl-2-pyrrolidone, N-ethyl-2-pyrrolidone, N-n-butyl-2-pyrrolidone, N-tert-butyl-2-pyrrolidone, N-cyclohexyl-2-pyrrolidone, N-n-butylpyrrolidone, N-isobutylpyrrolidone, N-t-butylpyrrolidone, N-n-pentylpyrrolidone, N-(methyl-substituted butyl)pyrrolidones, phenyl-methyl-substituted N-propylpyrrolidone, phenyl-methyl-substituted N-butyl pyrrolidone, N-(methoxypropyl)pyrrolidone, 1,5-dimethyl-pyrrolidone, and mixtures of any of the aforementioned. The synthesis of phenyl pyrrolidones is known to the art. J. P. Hilton-Proctor et al., “Substituted 1-methyl-4-phenylpyrrolidin-2-ones—Fragment-based design of N-methylpyrrolidone-derived bromodomain inhibitors” Eur. J. Med. Chem., 191(1) 2020, 112120. N-methyl-2-pyrrolidone is classified by the European Chemicals Agency as a “Substance of Very High Concern” and while operative herein is readily substituted in an inventive composition in all or part by other of the pyrrolidones (I). The pyrrolidone solvent is typically being present from 5 to 45 total weight percent and in specific embodiments between 15 and 35 total weight percent.

Non-ionic surfactants operative herein in some inventive embodiments have hydrophile/lipophile balance (HLB) values between 8 and 13. Classes of non-ionic surfactants operative herein include C₉-C₂₄ fatty acid esters, C₁₂-C₂₄ fatty alcohol ethers, C₁₀-C₂₄ amine oxides, nonylphenol ethoxylate, alkyl polyglucosides with C₈-C₁₆ alkyl chain, each alone or any of the aforementioned in combination. Other alcohol alkoxylates operative herein have the general formula (II):

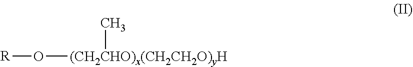

where R is C₄-C₂₂ linear or branched chain alkyl or mixtures thereof; x has a value of from 2 to 20; y has a value of from 0 to 15, or the general formula (III):

RO—(CH₂CH₂O)ₙ—H (III)

where n is average moles of ethylene oxide (EO) and R is a C₉-C₁₈ alkyl.

Specific non-ionic surfactants operative herein illustratively include alcohol C₁₂-C₁₅ ethoxylated propoxylated, C₁₂-C₁₄, ethoxylated, C₉₋₁₁ ethoxylated alcohols having EO values from 2.5-9, or combinations thereof. In some inventive embodiments, EO 2.5 C₉₋₁₁ ethoxylated alcohol is used in combination with one or more EO 6-9 C₉₋₁₁ ethoxylated alcohols.

Still other non-ionic surfactants operative herein include mixed ethylene oxide propylene oxide block copolymers, room temperature liquid polyethylene glycols, ethylene glycol monoesters, ethoxylated dibenzylphenol, amine oxides alkyl sugar esters such as alkyl sucrose esters and alkyl oligosaccharide esters, alkyl capped polyvinyl alcohol and alkyl capped polyvinyl pyrrolidone.

It should be appreciated that in some inventive embodiments, at least two non-ionic surfactants are present with HLB values that vary from one another. In certain inventive embodiments a first non-ionic surfactant has a first surfactant HLB value of between 6 and 9 total weight percent, while a second non-ionic surfactant has a second surfactant HLB value of between 12 and 16. Typical loadings of all non-ionic surfactants present in an inventive composition range from 10 to 40 total weight percent and in specific embodiments between 20 and 30 total weight percent. A particularly suitable surfactant combination may contain a ratio of first non-ionic surfactant to second non-ionic surfactant ranging between 0.4-2:1.

A co-solvent or blend of co-solvents is provided improves the sealant removal properties of an inventive composition. In specific inventive embodiments, the composition excludes the conventional solvents of citrus terpenes, such as d-limonene; ketones, such as acetone, methyl ethyl ketone, methyl isobutyl ketone, mesityl oxide, and isophorone; and petroleum distillates to achieve higher flash points of >70° C. and better handling property compositions. Typical loadings of all co-solvents present in an inventive composition range from 60 to 90 total weight percent and in specific embodiments between 70 and 80 total weight percent.

One class of co-solvent according to the present invention include polyalkoxys that are glymes, polyethers, or a combination thereof. A glyme operative herein has the structure (IV):

R—(OCHR¹CHR¹)ₙ—OR (IV)

where R in each occurrence is independently C₁-C₃ linear alkyl; R¹ in each occurrence is independently C₁-C₃ linear alkyl and n is an integer value between 1 and 10. Specific glymes operative herein include monoglyme, diglyme, triglyme, tetraglyme, ethyl glyme, ethyl diglyme, ethyl triglyme, ethyl tetraglyme, dipropylene glycol dimethyl ether, polyglyme, and mixtures of any of the aforementioned, A polyether operative herein has the structure (V):

R[—(O—R¹—O—R²—]ₙ (V)

where R is C₁-C₁₂ linear alkyl; R¹ in each occurrence is independently C₁-C₁₂ linear alkyl, C₁-C₁₂ branched alkyl, C₅-C₁₂ cyclic alkyl; R² in each occurrence is independently C₁-C₁₂ linear alkyl, C₁-C₁₂ branched alkyl, C₅-C₁₂ cyclic alkyl; and n is an integer value between 1 and 50. Cyclic forms of the aforementioned are also operative herein. Specific polyethers operative herein include tetraoxaundecane, 1,3-dioxacyclopentane, 5-hydroxy-1,3-dioxane, 4-hydroxymethyl-1,3-dioxolane, tetrahydrofurfuryl alcohol, and mixtures of any of the aforementioned. Polyalkoxy co-solvent is typically being present from 10 to 30 total weight percent and in specific embodiments between 15 to 25 total weight percent.

Other suitable co-solvents operative herein are acetals. Specific acetals operative herein illustratively include diethoxymethane, dimethoxymethane, 1,3-dioxolane and mixtures of any of the aforementioned. Acetal co-solvent is typically being present from 10 to 30 total weight percent and in specific embodiments between 15 and 25 total weight percent.

Other suitable co-solvents operative herein are amides. An amides operative herein as has the general formula (VI):

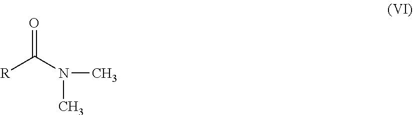

where R is hydrogen, C₁-C₁₂ linear alkyl, C₁-C₁₂ branched alkyl, C₅-C₁₂ cyclic alkyl, or C₁-C₁₂ linear alkoxy Specific amides operative herein illustratively include N,N-dimethyl formamide, acetamide, N,N-dimethyl acetamide, N,N-dimethylcapryilamide, N,N-dimethyloctanamide, N,N-dimethyldecanamide, and mixtures of any of the aforementioned. Amide co-solvent is typically being present from 10 to 40 total weight percent and in specific embodiments between 20 and 30 total weight percent.

A wetting agent present in some inventive embodiment and has an HLB value of between 3 and 10 to promote solubilization of the composition constituents. Wetting agents operative herein illustratively include branched secondary alcohol ethoxylate, 8-11 EO, sulfo-succinamates that illustratively include disodium N-octadecylsulfo-succinamate; tetrasodium N-(1,2-dicarboxyethyl)-N-octadecylsulfo-succinamate; diamyl ester of sodium sulfosuccinic acid; dihexyl ester of sodium sulfosuccinic acid; and dioctyl esters of sodium sulfosuccinic acid; dihexyl ester of sodium sulfosuccinic acid; and dioctyl esters of sodium sulfosuccinic acid; castor oil and fatty amine ethoxylates; lecithin; fatty acids, salts thereof, ethanolamides thereof, and glycerides thereof; sodium polycarboxylate; sodium salt of naphthalene sulfonate condensate; calcium naphthalene sulfonates; sodium lignosulfonates; aliphatic alcohol ethoxylates; ethoxylated tridecyl alcohols; ethoxylated tristearyl phenols; sodium methyl oleyl taurate; tristyrylphenol ethoxylates; ethylene oxide-propylene oxide block copolymers; sodium dodecylbenzene sulfonate; N-oleyl N-methyl taurate; 1,4-dioctoxy-1,4-dioxo-butane-2-sulfonic acid; sodium lauryl sulphate; sodium dioctyl sulphosuccinate; aliphatic alcohol ethoxylates; nonylphenol ethoxylates; salts of maleic anhydride copolymers; n-octyl-2-pyrrolidone, polyvinylpyrrolidone; polyvinyl alcohols, modified or unmodified starches, methylcellulose; hydroxyethyl or hydroxypropyl methylcellulose; carboxymethyl methylcellulose; polyalkyleneimines, such as polyethyleneimine; and combinations thereof. The function of the wetting agent is to spread the composition onto and to penetrate the sealant. The wetting agent is typically being present from 0 to 15 total weight percent and in specific embodiments between 5 and 10 total weight percent.

Other additives present in certain embodiments of an inventive composition illustratively include solubilizing agents, dyes, fragrances, thickeners, water, and combinations thereof. Each additive is independently present from 0 to 5 total weight percent and in specific embodiments between 0.5 and 3 total weight percent.

A solubilizing agent is a surfactant present to promote the dispersion of one of the other additives. The solubilizing agent can be one of the aforementioned non-ionic surfactants, and in such instances is counted as part of the amount of non-ionic surfactant. Monoethanolamine is exemplary of solubilizing agent operative herein.

A dye is typically being present from 0 and 5 total weight percent and in specific embodiments between 0 and 1 total weight percent.

The fragrance is typically being present from 0 and 5 total weight percent and in specific embodiments between 0 and 1 total weight percent.

A dye operative herein illustratively includes a fluorescent tracer dye. The dye is typically being present from 0 and 1 total weight percent and in specific embodiments between 0 and 0.25 total weight percent.

A thickener operative herein illustratively includes cellulosic thickeners. The thickener is typically being present from 0 and 5 total weight percent and in specific embodiments between 0 and 1 total weight percent.

It is appreciated that an inventive solvent composition is readily provided in an aerosol container having a volume and an aperture. The container is formed from a material that is compatible with the inventive composition and includes a container wall or at least liner contacting the volume in which the solvent resides that is illustratively formed from metals such as tin plated steel, aluminum; glass; or polymer coated steel. A spray nozzle is provided to selectively seal the aperture. In inventive embodiments inclusive of a propellant, a one piece valve is preassembled with the valve cup, dip tube, and actuator, can as unitary assembly, and prior to pressure-filling.

In a particular inventive embodiment, the propellant is one conventional to the field and compatible with the composition. Propellants operative herein illustratively include is carbon dioxide, nitrogen, halocarbons, butane, isobutane, propane, or dimethyl ether. The propellant, if present. is present in an amount of from 1 to 5 weight percent of the inventive composition. The propellant is not included in the total amounts of the present invention provided in the Table.

The process of usage of an inventive composition for removal of sulfur-containing polymer sealants or silicone sealants commonly used in the aerospace, automotive, construction, and insulating-glass industries includes applying the composition directly to the sealant. As noted above, an inventive composition is effective in removal of uncured, partially cured, and fully cured sealants. The sealant remover composition is readily applied by any conventional technique. For example, a sealant material can be dipped or soaked in a tank containing the inventive sealant remover composition. If desired, the sealant remover can be sprayed, brushed, or rolled onto the surface.

Normally, exposing the sealant to an inventive composition for from 30 to 120 minutes hours is effective to swell and otherwise promote removal of the sealant. The sealant substrate can be metal, including aluminum and steel, glass, concrete, all of which are not damaged by an inventive composition removing a sealant therefrom. Manually applied pressure transmitted via a cloth or scrapping blade is used in some instances to removal softened sealant. The process of application of the inventive composition is readily repeated as needed.

The following examples merely illustrate the invention. Those skilled in the art will recognize many variations that are within the spirit of the invention and scope of the claims.

### Example 1

Aluminum 2024-T3 panels (4×6 in) are prepared and coated with an aerospace grade epoxy primer per manufacturer's specification. The primed tested panels are allowed to fully cure for 168 hours at 25° C. prior to application of the sealant. The test panels are coated with the Polysulfide sealant in strips 6-8 mm wide and to a thickness of 6 mm; multiple strips are applied to the surface of a test panel for evaluation. Faring the edges along the test strips improves adhesion properties for testing purposes and is a common practice for an in-field application.

The sealant is cured for at 168 hours at 25° C. Sealant remover is applied to the sealant surface in an amount to fully coat the test sealant strip. The sealant remover remains on the surface until the sealant is sufficiently softened to be manually removed with a plastic scraper.

Lift times are noted when the sealant is completely removed from the coupon.

### Example 2

An inventive sealant removal composition is formed with 20 total weight percent of 1-butylpyrrolidin-2-one; co-solvent of 25 total weight percent of equal weight amounts of N,N-dimethyloctanamide and N,N-dimethyldecanamide; and 25 total weight percent of tetraoxaundecane; 18 total weight percent of nonionic alkoxylated alcohol with an HLB of 12; 12 total weight percent of nonionic alkoxylated alcohol with an HLB of 6. The resulting composition has very low odor profile and no irritating fumes in confined spaces or enclosed work areas.

### Example 3

The composition of Example 2 is tested and found to have a flashpoint >70° C. as measured by per ASTM D3278-96 (2011), both as normalized to standard temperature and pressure (STP). It is noted that the resulting slow evaporation increases contact (dwell time) thereby reducing the need for re-application. An inventive composition is considered by as combustible versus flammable.

### Example 4

The coupons of Example 1 are exposed to the composition of Example 2. The composition of Example 2 is noted to remove more than 95% of the sealant with a lift time of less than 60 minutes.

### COMPARATIVE EXAMPLES

Methyl ethyl ketone (MEK), and monoethylene glycol have a limited ability to remove uncured (4 hours after mixing) PPG PR-1776M class B polysulfide, but are unable to remove the cured sealant.

50% N-methyl-2-pyrrolidone in aromatic hydrocarbons is used to remove PPG PR-1776M class B polysulfide provided the majority, but not all of the sealant compared to Example 4, a partial lift time of more than 100 minutes is noted. [PLEASE SEE U.S. Pat. No. 5,561,215; TABLE 2 for basis]

### Example 5

The coupons of Example 1 are reproduced with a like thickness of commercially available polythioether sealant and cured per Example 1. The composition of Example 2 is effective to remove the sealant.

Patents and publications mention the specification are indicative of the levels of those skilled in the art to which the invention pertains. These patents and publications are incorporated herein by reference to the same extent as if each individual patent or publication was specifically and individually incorporated herein by reference.

The forgoing description is illustrative of particular embodiments of the invention but is not meant to be a limitation upon the practice thereof. The following claims, including all equivalents thereof are intended to define the scope of the invention.

1. A sealant removal composition comprising:
one or more pyrrolidone solvents;
a non-ionic surfactant;
at least one co-solvent; and
optionally at least one additive of solubilizing agents, dyes, fragrances, thickeners, water, and combinations thereof.

2. The sealant removal composition of claim 1 wherein said one or more pyrrolidone solvent is present up to 45 total weight percent.

3. The sealant removal composition of claim 1 wherein said pyrrolidone solvent has the cyclic structure (I): 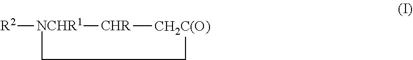
where R¹ is hydrogen, or C₁-C₃ linear alkyl; R² is hydrogen, C₁-C₁₂ linear alkyl, C₁-C₁₂ branched alkyl, C₅-C₁₂ cyclic alkyl, or C₁-C₁₂ linear alkoxy; and R is hydrogen, or —C₆R³₅; where R³ in each occurrence is independently hydrogen, —C₆H₅, and substituted C₆ aryl with one or more hydrogen substituted by C₁-C₁₂ linear alkyl, C₁-C₁₂ branched alkyl, or C₅-C₁₂ cyclic alkyl.

4. The sealant removal composition of claim 1 wherein said pyrrolidone solvent is pyrrolidone, N-methyl-2-pyrrolidone, N-ethyl-2-pyrrolidone, N-n-butyl-2-pyrrolidone, N-tert-butyl-2-pyrrolidone, N-cyclohexyl-2-pyrrolidone, N-n-butylpyrrolidone, N-isobutylpyrrolidone, N-t-butylpyrrolidone, N-n-pentylpyrrolidone, N-(methyl-substituted butyl)pyrrolidones, phenyl-methyl-substituted N-propylpyrrolidone, phenyl-methyl-substituted N-butyl pyrrolidone, N-(methoxypropyl)pyrrolidone, 1,5-dimethyl-pyrrolidone, and mixtures of any of the aforementioned.

5. The sealant removal composition of claim 1 wherein said pyrrolidone solvent comprises 1-butylpyrrolidin-2-one.

6. The sealant removal composition of claim 1 wherein said first non-ionic surfactant has a first surfactant HLB value of between 6 and 9 and said second non-ionic surfactant has a second surfactant HLB value of between 12 and 16.

7. The sealant removal composition of claim 1 wherein said at least one co-solvent is present up to 90 total weight percent.

8. The sealant removal composition of claim 1 said at least one co-solvent comprises at least one of a glyme, a polyether, an amide, or an acetal.

9. The sealant removal composition of claim 8 wherein said glyme is present and has the structure (IV):
R—(OCHR¹CHR¹)ₙ—OR (IV)
where R in each occurrence is independently C₁-C₃ linear alkyl; R¹ in each occurrence is independently C₁-C₃ linear alkyl and n is an integer value between 1 and 10.

10. The sealant removal composition of claim 8 wherein said polyether is present and has the structure (IV):
R[—(O—R¹—O—R²—]ₙ (V)
where R is C₁-C₁₂ linear alkyl; R¹ in each occurrence is independently C₁-C₁₂ linear alkyl, C₁-C₁₂ branched alkyl, C₅-C₁₂ cyclic alkyl; R² in each occurrence is independently C₁-C₁₂ linear alkyl, C₁-C₁₂ branched alkyl, C₅-C₁₂ cyclic alkyl; and n is an integer value between 1 and 50.

11. The sealant removal composition of claim 8 wherein said polyether is present and comprises: tetraoxaundecane, 1,3-dioxacyclopentane, 5-hydroxy-1,3-dioxane, 4-hydroxymethyl-1,3-dioxolane, tetrahydrofurfuryl alcohol, and mixtures of any of the aforementioned.

12. The sealant removal composition of claim 8 wherein said acetal is present and comprises: diethoxymethane, dimethoxymethane, 1,3-dioxolane and mixtures of any of the aforementioned.

13. The sealant removal composition of claim 8 wherein said polyether is present and has the general formula (VI): 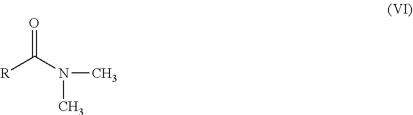
where R is hydrogen, C₁-C₁₂ linear alkyl, C₁-C₁₂ branched alkyl, C₅-C₁₂ cyclic alkyl, or C₁-C₁₂ linear alkoxy.

14. The sealant removal composition of claim 8 wherein said amide is present and comprises: N,N-dimethyl formamide, acetamide, N,N-dimethyl acetamide, N,N-dimethyloctanamide, N,N-dimethyldecanamide, and mixtures of any of the aforementioned.

15. The sealant removal composition of claim 1 wherein the composition is exclusive of at least one of solvent of d-limonene; acetone, methyl ethyl ketone, methyl isobutyl ketone, mesityl oxide, isophorone; and petroleum distillates or all of the solvents.

16. The sealant removal composition of claim 1 having a flash point of above >70° C. at 760 torr.

17. A process of removing a sealant from a substrate comprising:
applying the composition of claim 1 to the sealant; and
allowing dwell time for sealant to swell on the substrate.

18. The process of claim 17 further comprising applying mechanical force to the sealant while the sealant is in contact with the composition.

19. The process of claim 17 wherein the sealant is a silicone or sulfur-containing polymers.

20. The process of claim 17 wherein the substrate is one of glass, metal, or concrete.
